(19) United States
(12) Patent Application Publication
(10) Pub. No.: US 2025/0335671 A1
(43) Pub. Date: Oct. 30, 2025

(54) PREDICTING PHYSICAL MODALITIES OF POWER ELECTRONIC DEVICES

(71) Applicant: Analog Devices, Inc., Wilmington, MA (US)

(72) Inventors: Wenjie Lu, Arlington, MA (US); Tao Yu, Needham Heights, MA (US); Tong Jian, Boston, MA (US)

(21) Appl. No.: 19/195,282

(22) Filed: Apr. 30, 2025

Related U.S. Application Data
(60) Provisional application No. 63/640,721, filed on Apr. 30, 2024.

(51) Int. Cl. G06F 30/27; G06F 119/06

(52) U.S. Cl. CPC G06F 30/27; G06F 2119/06

(57) ABSTRACT

Power electronic device prediction systems and methods for using power electronic device models to predict the physical modalities of unknown power electronic devices. These unknown power electronic devices have not been seen previously by the power electronic device models. For example, if the class of power electronic devices is power converters, then a power converter model is trained on known physical modalities from different power converters and the model is used to predict an unknown physical modality of a power converter that the model has not seen before. In some examples, the training is unsupervised, such that the training data is unlabeled. In other examples, the training uses self-supervised techniques using unlabeled training data and then the model is refined using few-shot learning techniques and a small amount of labeled training data. This allows the models to quickly adapt to predict the physical modalities of unknown power electronic devices.

### CLAIM OF PRIORITY

This patent application claims the benefit of priority to U.S. Provisional Application Ser. No. 63/640,721, filed Apr. 30, 2024, which is incorporated by reference herein in its entirety.

### TECHNICAL FIELD

This document pertains generally, but not by way of limitation, to machine learning technologies and, more particularly, to predictive modeling of power electronic devices using a generalized machine learning model.

### BACKGROUND

Power electronic devices facilitate the conversion, control, and management of electrical power across a wide range of applications, including renewable energy systems, electric vehicles, consumer electronics, and industrial automation. These devices encompass various classes, such as power converters, voltage regulators, motor drives, switching devices, uninterruptible power supplies, and power conditioning systems. Predicting the physical modalities (or physical characteristics, parameters, and responses) of these power electronic devices provides insight into the behavior of these devices under various operational conditions. Accurate predictions of physical modalities, such as time-domain transient responses, frequency-domain loop responses, and circuit parameters, enable effective modeling of device behavior, optimization of their performance, and assessment of their reliability.

### SUMMARY

The described examples relate to a power electronic device prediction systems and methods that address the limitations of existing methodologies by introducing a unified machine learning framework. This framework is implemented as power electronic device models capable of generalizing across various architectures, topologies, and configurations of power electronic devices. The described examples enable the training of a single comprehensive model that can be applied to any power electronic device, including power converters, to predict their physical modalities, even for devices the model has not previously encountered.

The described examples include methods for modeling power electronic devices, including power converters. These methods involve training a power electronic devices model using training data that includes physical modalities from multiple power electronic devices with diverse architectures and configurations. The physical modalities include characteristics such as time-domain transient responses, frequency-domain loop responses, and circuit design parameters, which influence the behavior of power electronic devices under different operational conditions. The methods further include using the trained models to predict at least one physical modality of an unknown power electronic device, where the unknown power electronic device is one that has not been seen before by the power electronic devices model.

The described system includes several components including physical modality encoders that transform raw data, such as transient responses and Bode plots, into embeddings, which are lower-dimensional representations of the data. These embeddings are mapped into a latent space that represents relationships between the physical modalities. The latent space enables transformations between modalities, such as converting transient responses to Bode plots or circuit parameters. A mapping model predicts unknown embeddings based on known embeddings, and physical modality decoders reconstruct raw data from embeddings to generate outputs, such as predicted transient responses or circuit parameters.

Some of the described examples use self-supervised learning techniques to train the models. These approaches do not require labeled data and instead rely on solving pretext tasks to extract meaningful features from unlabeled datasets. Once trained, some examples of the models are refined using few-shot learning, which uses a small number of labeled examples to adapt the models to new power electronic devices. This combination of self-supervised learning techniques and few-shot learning techniques reduces the data collection burden and allows the models to quickly adapt to unseen devices. The described examples also include mechanisms to handle real-world data imperfections. A prior model predicts missing embeddings based on available ones, addressing noise and missing values in the data. This ensures robust predictions even when the input data is incomplete or noisy. The systems also include an output that contains both the known physical modalities and the predicted physical modality for the unknown power electronic device.

Additionally, disclosed examples include a non-transitory computer-readable storage medium containing instructions. When executed by a computer, these instructions perform operations for predicting an unknown physical modality of a power converter. These operations include receiving several known physical modalities of the power converter, mapping the known physical modalities into a latent space, and using the power converter model to predict the unknown physical modality in the latent space. The output includes both the known physical modalities and the predicted physical modality of the power converter. Some of the described examples are modular, allowing physical modality encoders, the mapping model, and physical modality decoders to be trained independently or jointly. This modularity provides flexibility in model design and training, enabling customization for specific use cases. While the described examples focus on power converters, the framework can also be applied to other analog subsystems, such as RF signal chains, which share similar characteristics, such as input and output measurements in time and frequency domains.

This summary is intended to provide an overview of subject matter of the present patent application. It is not intended to provide an exclusive or exhaustive explanation. The detailed description is included to provide further information about the described examples.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various examples discussed in the present disclosure.

FIG. 1 illustrates an overview of examples of power electronic device prediction systems described herein.

FIG. 2 is a block diagram illustrating components of examples of power electronic device models shown in FIG. 1.

FIG. 3 illustrates examples of self-supervised pre-training of the mapping models shown in FIG. 2.

FIG. 4 is a block diagram illustrating examples of the power electronic device prediction systems being used to predict physical modalities of a power converter.

FIG. 5 is a block diagram showing examples of architectures for computing devices on which examples of the power electronic device prediction systems can be implemented.

FIG. 6 is a block diagram illustrating examples of a computer systems for executing instructions to perform operations of the power electronic device prediction systems discussed herein.

### DETAILED DESCRIPTION

### Overview

Traditional modeling methods modeling methods for power electronic devices, such as mathematical equations and Simulation Program with Integrated Circuit Emphasis (SPICE) simulations, use extensive manual calibration to align simulation results with real-world measurements. While SPICE simulations can capture certain transient responses, they struggle to account for nonlinearities and parasitic effects inherent in power electronic devices. This calibration process is labor-intensive, time-consuming, and prone to inaccuracies, particularly for devices with complex architectures or configurations, and fails to provide accurate predictions across diverse devices and operational conditions.

Recent advancements in machine learning have introduced data-driven methods as an alternative to traditional modeling approaches. Artificial intelligence (AI) models offer the potential to predict the behavior of power electronic devices by learning from large datasets. However, these models are typically trained on data from a single device or product, making them reliant on device-specific datasets and limiting their scalability. New devices require additional data collection and retraining of separate models, and AI models often struggle to generalize to devices or configurations not encountered during training. Furthermore, both traditional and AI-based methods face challenges in handling real-world data imperfections, such as noise, missing values, and dynamic variations, which are common in power electronic devices.

The described examples address the challenges faced by traditional and data-driven approaches in modeling power electronic devices. Unlike conventional methods that rely on extensive manual calibration and struggle with nonlinearities and parasitic effects, the described examples introduce generalized machine learning models capable of predicting physical modalities across diverse architectures, topologies, and configurations. These models eliminate the need for individual models tailored to specific devices by leveraging a unified latent space to represent relationships between transient waveforms, frequency-domain responses, and circuit parameters. The latent space enables transformations between modalities, allowing the model to generalize to unseen devices and configurations. These approaches address scalability issues and reduces the data collection burden while maintaining high accuracy and adaptability.

The described examples employ self-supervised learning techniques to train the models using unlabeled datasets, extracting meaningful features without relying on labeled data. Once trained, the models are refined using few-shot learning, which uses a small number of labeled examples to adapt the model to new devices. Few-shot learning allows the models to handle unseen data efficiently, making it suitable for dynamic and evolving environments.

Additionally, the described examples include mechanisms to address real-world data imperfections, such as noise and missing values, by predicting missing embeddings based on available ones. This ensures robust predictions even when input data is incomplete or noisy. The framework is modular, allowing components such as encoders, mapping models, and decoders to be trained independently or jointly, providing flexibility for specific use cases. Furthermore, the methodology is not limited to power converters and can be applied to other analog subsystems, such as RF signal chains, broadening its applicability across various domains. By addressing the limitations of existing methods, the described examples offer a scalable, adaptable, and efficient solution for modeling and optimizing power electronic devices.

### Power Electronic Device Prediction System

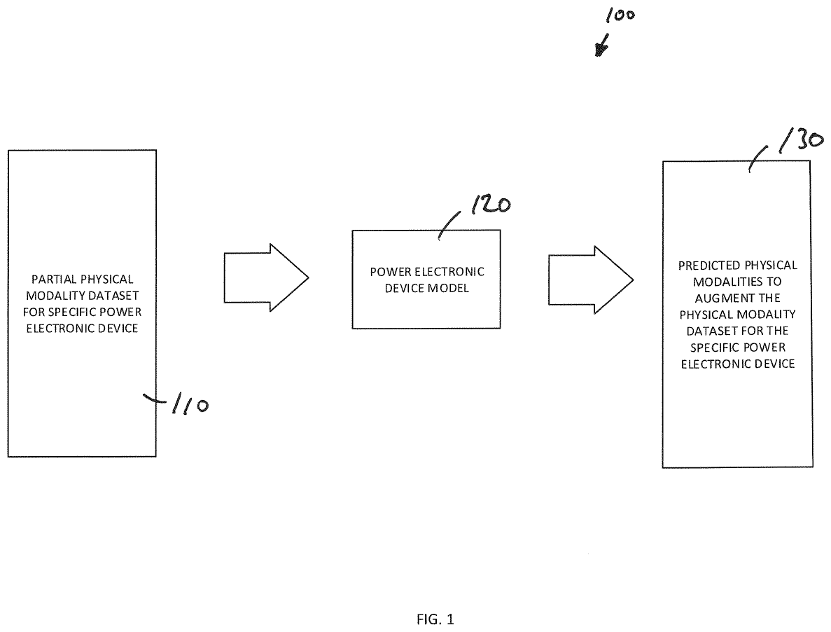

FIG. 1 illustrates an overview of examples of power electronic device prediction systems described herein. As shown in FIG. 1, the power electronic device prediction system 100 generally has three phases or parts. First, a partial physical modality dataset 110 is used by the power electronic device prediction system 100 to make predictions for a specific power electronic device. For example, if the power electronic device is a power converter, then the partial physical modality dataset 110 can include data such as Bode plots, transient responses, and circuit parameters of the specific power converter.

Second, the power electronic device prediction system 100 includes a power electronic device model 120 that is a self-supervised generalized machine learning model using few-shot learning. The power electronic device model 120 uses the partial physical modality dataset 110 to obtain predicted physical modalities 130. Third, the predicted physical modalities 130 augment the partial physical modality dataset 110 with additional physical modalities that have been predicted by the power electronic device model 120. In some examples, the predicted physical modalities 130 are a single physical modality. In other examples, the predicted physical modalities 130 are a plurality of predicted physical modalities that augment the partial physical modality dataset 110.

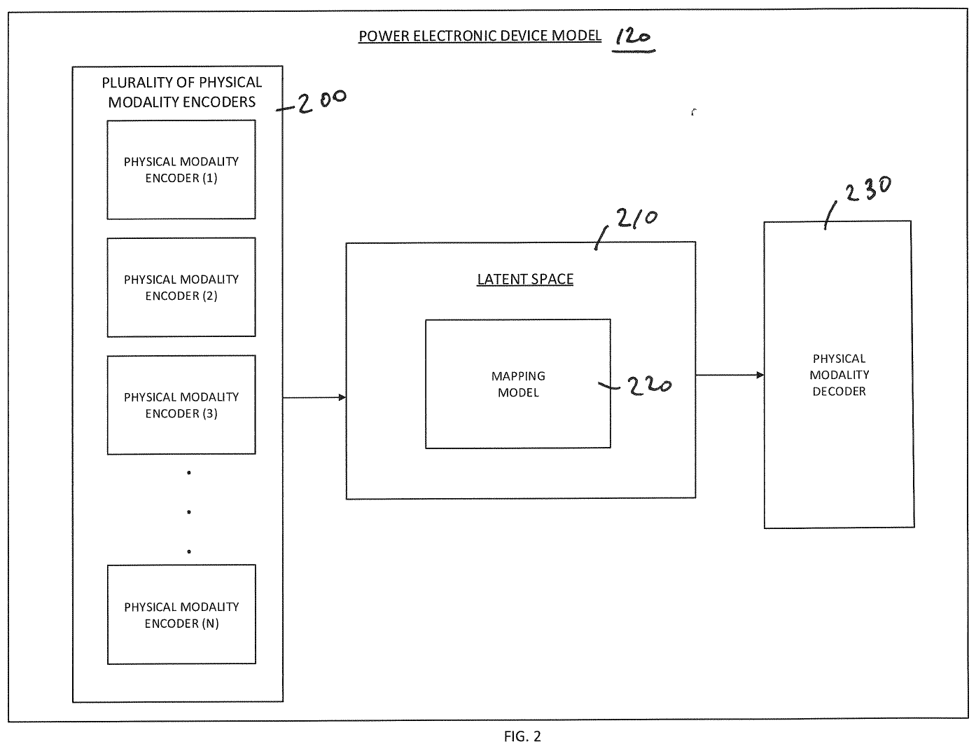

FIG. 2 is a block diagram illustrating components of examples of power electronic device models shown in FIG. 1. The power electronic device model 120 includes a plurality of physical modality encoders 200. The plurality of physical modality encoders 200 includes N number of physical modality encoders, where N is a positive integer greater than or equal to one. As shown in FIG. 2, the plurality of physical modality encoders 200 includes a physical modality encoder (1), a physical modality encoder (2), a physical modality encoder (3), and so on to a physical modality encoder (N).

In general, each of the encoders of the plurality of physical modality encoders 200 maps the input data into a latent space 210. Each encoder is responsible for transforming the input data into a lower-dimensional representation (also called an “embedding”) of the latent space 210 (also known as a “latent representation”). This process involves compressing the input data into a more compact and informative representation that maintains the input data's core features.

The latent space 210 also includes a mapping model 220. The power electronic device model 120 uses the mapping model 220 to map a lower-dimensional representation of known physical modalities to one or more predicted physical modalities. The mapping model 220 maps the embeddings into a latent space configured to represent relationships between known physical modalities of power electronic devices. In some examples, the mapping model 220 is a machine learning model that is trained as described below. The mapping model 220 takes known physical modalities and unknown physical modalities about a particular power electronic device and maps them to a common space so that they can be decoded. In other words, the mapping model 220 predict at least one predicted embedding based on known embeddings.

In some examples, the mapping model 220 is implemented using a generative approach, including autoregressive or diffusion models, to predict embeddings in the latent space. Generative approaches involve models that learn the underlying data distribution to synthesize novel, realistic samples. Example methods include autoregressive models, which generate data sequentially, and diffusion models, which iteratively denoise random inputs to produce high-quality outputs.

Examples of the power electronic device model 120 also include a physical modality decoder 230. The physical modality decoder 230 takes the encoded representation from the latent space 210 and reconstructs the original input data. The physical modality decoder 230 performs the inverse operation of each encoder of the plurality of physical modality encoders 200, mapping points from the latent space 210 back to an original input space. The task of the physical modality decoder 230 is to generate outputs that closely resemble the inputs, based on the information encoded in the latent space 210.

Each encoder of the plurality of physical modality encoders 200 and that physical modality decoder 230 are not themselves part of the latent space 210. Rather, they both are components used to transform data between the input space and the latent space 210, particularly in examples where the power electronic device model 120 is an autoencoder-based model or a variational autoencoder (VAE).

### Self-Supervised Pre-Training of the Mapping Model

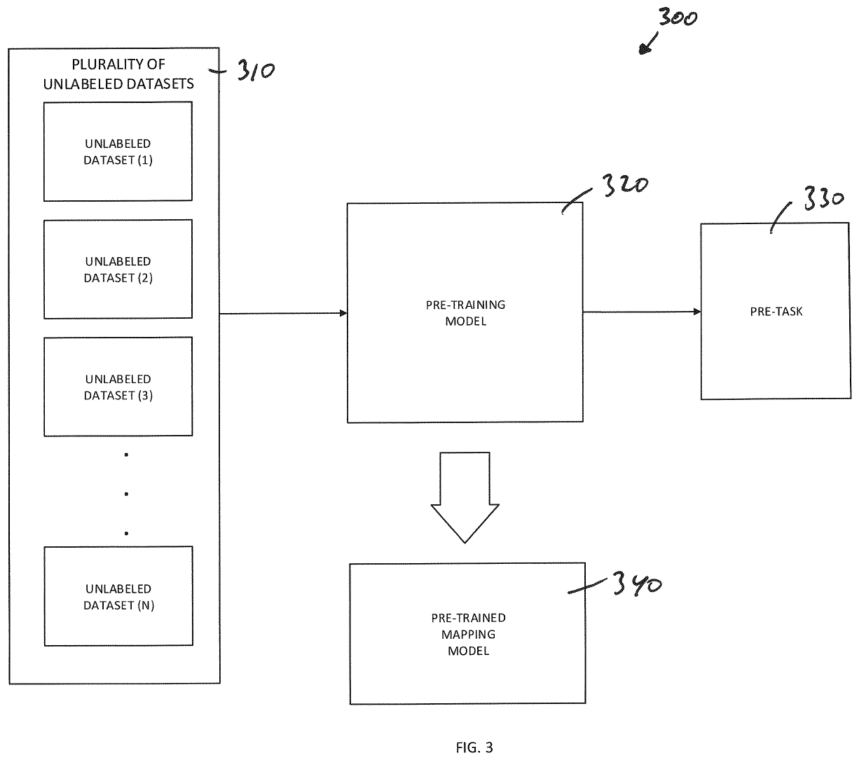

FIG. 3 illustrates examples of self-supervised pre-training 300 of the mapping models 220 shown in FIG. 2. The self-supervised pre-training 300, in some examples, includes input data that are a plurality of unlabeled datasets 310. The plurality of unlabeled datasets 310 includes physical modalities of a variety for a particular class of power electronic devices, such as power converters. As shown in FIG. 3, the plurality of unlabeled datasets 310 includes an unlabeled dataset (1), unlabeled dataset (2), unlabeled dataset (3), up to unlabeled dataset (N).

In some examples, initially the power electronic device model 120 undergoes the self-supervised pre-training 300 using the plurality of unlabeled datasets 310, without requiring explicit labels. This phase allows the power electronic device model 120 to learn meaningful representations of the plurality of unlabeled datasets 310.

A pre-training model 320 and a pre-task 330 serve as a starting point for the creation of a pre-trained mapping model 340. In self-supervised learning for machine learning models, the pre-task 330 plays a role in shaping the learning process and enabling the pre-training model 320 to acquire meaningful representations of the input data, the plurality of unlabeled datasets 310. The pre-task 330 is designed to encourage the pre-training model 320 to learn useful representations of the plurality of unlabeled datasets 310 without relying on externally provided labels. Overall, the pre-task 330 serves as an intermediary step in the self-supervised learning process and guides the pre-training model 320 to learn meaningful representations of the data in a self-supervised manner.

In some examples, the pre-task 330 is selected based on the characteristics of the data and the specific problem to predict physical modality data for an unknown device in a particular class of power electronic device. The pre-task is a task that the pre-training model 320 can learn to solve by understanding the inherent structure or patterns present in the plurality of unlabeled datasets 310.

Once the pre-task 330 is selected, the pre-training model 320 is trained on the pre-task using self-supervised learning. The pre-training model 320 learns to make predictions based on various parts of the plurality of unlabeled datasets 310, using other parts of the same data as context. As the pre-training model 320 trains on the pre-task 330, it learns to extract meaningful features from the plurality of unlabeled datasets 310 that are relevant to solving the pre-task 330. These extracted features capture important patterns or relationships in the data and can be used to represent the plurality of unlabeled datasets 310 in a more compact and informative way.

Once the pre-training model 320 has been trained on the pre-task 330 and has learned useful representations and features, these representations and features can be transferred to create the pre-trained mapping model 340. The representations and features learned during the pre-task phase serve as a starting point for solving the task of predicting physical modalities for an unknown power electronic device.

The above example has described the self-supervised pre-training 300 of the mapping model 220 using an autoregressive prior. In other examples, the self-supervised pre-training 300 is performed using no prior. In still other examples, the self-supervised pre-training 300 is done using a diffusion prior. Each of these techniques are well known to those in the machine learning field.

### Few-Shot Learning Refinement

In some examples of the power electronic device prediction system 100, the pre-trained mapping model 340 is the mapping model 220 and is used to make prediction. In other examples of the power electronic device prediction system 100, following the self-supervised pre-training 300, the pre-trained mapping model 340 is fine-tuned or refined using few-shot learning. In these examples, a small number of labeled examples (shots) are used to adapt the pre-trained mapping model 340 to the task of predicting the specific physical modalities of a particular power electronic device. Once the pre-trained mapping model 340 has been fine-tuned using few-shot learning and has learned useful representations and features, these representations and features can be transferred to create the mapping model 220 shown in FIG. 2.

Combining the self-supervised pre-training 300 with few-shot learning allows some examples of the mapping model 220 to leverage the intrinsic structure of the input data and learn rich representations and features of the input data in a self-supervised manner. This enables the power electronic device prediction system 100 to generalize well to unknown power electronic devices, even with limited labeled data. Moreover, the power electronic device prediction system 100 can generalize well, even to those unknown power electronic devices that it has not seen.

### Power Converter Prediction Example

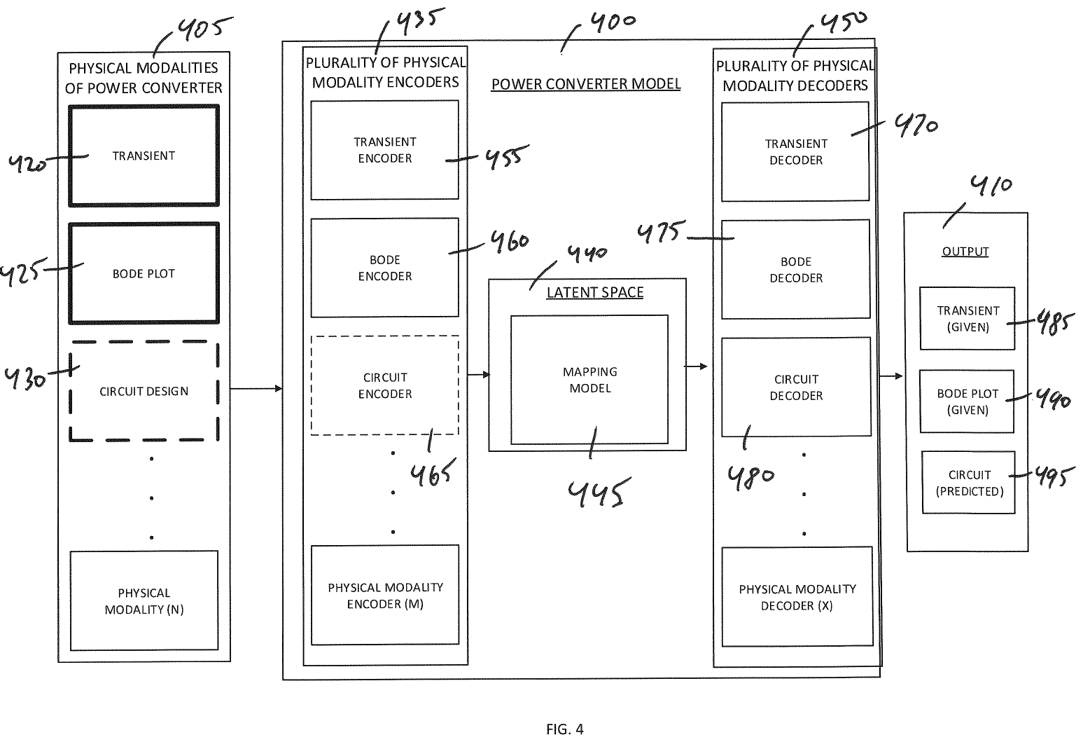

FIG. 4 is a block diagram illustrating examples of the power electronic device prediction systems 100 being used to predict physical modalities of a power converter. A power converter model 400 is an example of the power electronic device model 120 shown in FIGS. 1 and 2. The power converter model 400 leverages information from a plurality of physical modalities of the power converter 405 and adapts through few-shot learning to accurately predict missing physical modalities of a power converter it has not seen before.

In the example of FIG. 4, given some physical modalities of a particular power converter that the power converter model 400 has not seen before, the power converter model 400 used to predict one or more additional modalities of the power converter. In this example, the power converter model 400 is given a transient and a Bode plot of the power converter. Given these two modalities, the power converter model 400 predicts the circuit of the power converter. The power converter model 400 was previously trained on datasets collected from different types and model of power converters, each having various architectures.

As shown in FIG. 4, in some examples the plurality of physical modalities of the power converter 405 includes a collection of N physical modalities, including output transient 420, Bode plot 425, circuit design parameters 430, and other physical modalities to physical modality (N), where N is a positive integer greater than one. In this example, the output transient 420 and the Bode plot 425 are given, as shown by the heavy outline. The circuit design parameters 430 are not given, as shown by the dashed line. In other examples, any physical modality that represents the power converter can be included in the plurality of physical modalities of the power converter 405, including printed circuit board (PCB) designs, physical circuit parameters, additional transients, and additional Bode plots. Moreover, the plurality of physical modalities of the power converter 405 can include identical or similar modalities-they are not constrained to being different. In some examples, the plurality of physical modalities of the power converter 405 include multiple inputs of the same physical modality. For example, there can be more than one transient in the plurality of physical modalities of the power converter 405, even though one is shown in FIG. 4.

The power converter model 400 includes the plurality of physical modality encoders 200, the latent space 210 with the mapping model 220, and a plurality of physical modality decoders 450. In some examples, the plurality of physical modality encoders 200 includes a transient encoder 455, a Bode encoder 460, a circuit encoder 465, and up to physical modality encoder (M), where M is a positive integer greater than or equal to 1. In some instances, M equals N, which means that there are the same number of encoders and there are given physical modalities. In other instances, M is less than N, such as when there are multiple transients as input and a single transient encoder can encode each of the transients. In this example, the plurality of physical modality encoders 200 includes the transient encoder 455 and the Bode encoder 460. The circuit encoder 465 is not used, as shown by the dashed line, as the circuit design parameters 430 are not given as input.

The plurality of physical modality encoders 200 can be trained independently, using an individual model for each encoder. In other examples, the encoders are trained jointly, such as using a multi-way Contrastive Language-Image Pretraining (CLIP) with contrastive loss technique. In still other examples, the encoders are trained using a pair-wise technique that utilizes a discriminative model to map transients to Bode plots. Each approach offers distinct aspects, namely: (1) independent training operates without labeled data; (2) joint training typically involves partially labeled data; and (3) pair-wise training uses labeled data. Generally, more labeled data results in better mapping performance but can compromise generalization and involve insignificant data collection efforts.

The output of the plurality of physical modality encoders 200 are embedding of the physical modalities in the latent space 210. In some examples, the mapping model 220 of the latent space 210 is used to predict a third embedding, given any two embedding. In this example, given the transient embedding and the Bode plot embedding, the mapping function predicts a circuit parameter embedding. The overall idea is to map the transient embedding (or a time-domain output transient response) and the Bode embedding (or a frequency-domain loop response) of the power converter to the latent space 210. Given the transient embedding and the Bode embedding, the mapping model 220 is used to project these two embeddings to the circuit parameter embedding. Then, employing a specific decoder for that modality, the raw circuit parameter data is reconstructed.

Some physical modalities contain more information than other physical modalities. For example, the circuit parameter modality contains richer information than the transient modality. This means that given just the circuit parameter modality, in some cases it is possible to use the power converter model 400 to predict the transient and Bode plot modalities. But in this example, we have the output transient 420 modality and the Bode plot 425 modality to predict the circuit design parameters 430 modality. The quantity of physical modalities for predicting additional physical modalities depends on the data.

In some examples, the plurality of physical modality decoders 450 is a single decoder. In other examples, the plurality of physical modality decoders 450 includes a transient decoder 470, a Bode decoder 475, a circuit design parameter decoder 480, and up to physical modality encoder (X), where X is a positive integer greater than or equal to 1. In some instances, X is less than M and N, which means that one decoder can decode multiple physical modality embeddings. For example, the transient decoder 470 can decode different transient modalities. In this example, the plurality of physical modality decoders 450 includes the transient decoder 470, for decoding the transient embedding, the Bode decoder 475, for decoding the Bode embedding, and the circuit design parameter decoder 480, for decoding the circuit embedding that the mapping model 220 predicted and generated.

In some examples, a predicted embedding from the latent space is decoded using the plurality of physical modality decoders 450. Some examples configure the plurality of physical modality decoders to generate predicted physical modalities that include efficiency, power factor, harmonic distortion, or temperature stability of an unknown power electronic device. In some examples, the plurality of physical modality encoders and the plurality of physical modalities decoders form an autoencoder-based architecture, and the latent space is implemented using a variational autoencoder (VAE). In some examples, the plurality of physical modality decoders 450 decodes a predicted embeddings.

The plurality of physical modality decoders 450 can be trained concurrently with the plurality of physical modality encoders 200 or independently. If trained together, each encoder-decoder pair forms a conventional auto-encoder architecture. Alternatively, autoregressive or diffusion models can be employed for each decoder of the plurality of physical modality decoders 450. Regardless of the approach, an encoder and a decoder are used for each physical modality. The prediction of the physical modalities of a power converter can be achieved using one or more different combinations of the techniques described above. But the general framework remains the same.

An output 410 from the power converter model 400 are an augmented list of physical modalities of the power converter. As shown in FIG. 4, these physical modalities can include a given transient 485, which was given in the plurality of physical modalities of the power converter 405, and the given Bode plot 490, which was also given in the plurality of physical modalities of the power converter 405. In addition, the output 410 includes the predicted circuit parameter 495. In some examples, output 410 can be text. For example, if the output transient 420 is input, then the given transient 485 can be a description of that output transient 420 in the output 410. This means in these examples that the physical modality at the output 410 is not the same modality as the input. Instead, the output 410 is a language description of the physical modality.

### Computing Environment

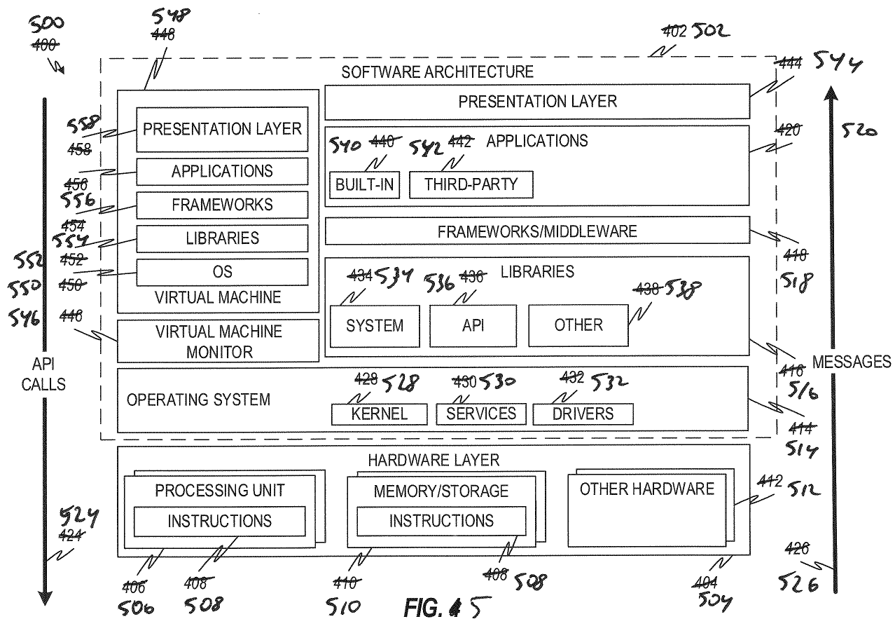

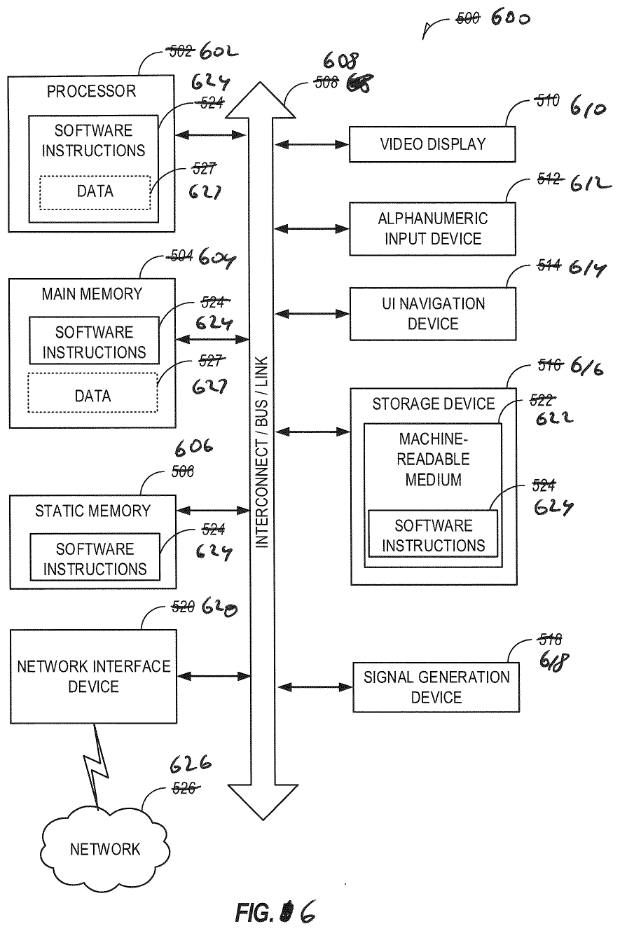

FIG. 5 is a block diagram showing examples of architectures 500 for computing devices on which examples of the power electronic device prediction systems 100 can be implemented. The architecture 500 can be used in conjunction with various hardware configurations as described above. FIG. 5 is merely a non-limiting example of a computing device supporting a software architecture 502, but it will be understood that many other architecture arrangements can be implemented to facilitate the functionality described herein. A representative example of a hardware layer 504 is also illustrated and can represent, for example, any of the above referenced computing devices or hardware components. In some examples, the hardware layer 504 can be implemented according to the architecture of the computer system of FIG. 6.

The hardware layer 504 comprises one or more processing units 506 having executable instructions 508. Executable instructions 508 represent the executable instructions of the software architecture 502, including implementation of the methods, modules, subsystems, and components, and so forth described herein and can also include memory and/or storage components 510, which also have executable instructions 508. Hardware layer 504 can also comprise other hardware as indicated by other hardware 512 which represents any other hardware of the hardware layer 504, such as the other hardware illustrated as part of the software architecture 502.

In the example architecture of FIG. 5, the software architecture 502 can be conceptualized as a stack of layers where each layer provides particular functionality. For example, the software architecture 502 can include layers such as an operating system 514, libraries 516, frameworks/middleware 518, applications 520, and presentation layer 544. Operationally, the applications 520 and/or other components within the layers can invoke messaging (e.g., with application programming interface (API) messages such as API calls 524) through the software stack and access a response, returned values, and so forth (e.g., illustrated as messages 526 in response to the API calls 524). The layers illustrated are representative in nature and not each software architecture has each layer. For example, some mobile or special-purpose operating systems can possibly not provide a frameworks/middleware 518, while others can provide such a layer. Other software architectures can include additional or different layers.

The operating system 514 can manage hardware resources and provide common services. The operating system 514 can include, for example, a kernel 528, services 530, and drivers 532. The kernel 528 can act as an abstraction layer between the hardware and the other software layers. For example, the kernel 528 can be responsible for memory management, processor management (e.g., scheduling), component management, networking, security settings, and so on. The services 530 can provide other common services for the other software layers. In some examples, the services 530 include an interrupt service. The interrupt service can detect the receipt of an interrupt and, in response, cause the software architecture 502 to pause its current processing and execute an interrupt service routine (ISR) when an interrupt is accessed.

The drivers 532 can be responsible for controlling or interfacing with the underlying hardware. For instance, the drivers 532 can include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 516 can provide a common infrastructure that can be utilized by the applications 520 and/or other components and/or layers. The libraries 516 typically provide functionality that allows other software components/modules to perform tasks in an easier fashion than to interface directly with the operating system 514 functionality (e.g., kernel 528, services 530 and/or drivers 532). The libraries 516 can include system libraries 534 (e.g., C standard library) that can provide functions such as memory allocation functions, string manipulation functions, mathematic functions, and the like. In addition, the libraries 516 can include API libraries 536 such as media libraries (e.g., libraries to support presentation and manipulation of various media formats), graphics libraries (e.g., libraries to render two-dimensional and three-dimensional in a graphic content on a display), database libraries (e.g., libraries that provide various relational database functions), web libraries (e.g., libraries that provide web browsing functionality), and the like. The libraries 516 can also include a wide variety of other libraries 538 to provide many other APIs to the applications 520 and other software components/modules.

The frameworks/middleware 518 can provide a higher-level common infrastructure that can be utilized by the applications 520 and/or other software components/modules. For example, the frameworks/middleware 518 can provide various graphic user interface (GUI) functions, high-level resource management, high-level location services, and so forth. The frameworks/middleware 518 can provide a broad spectrum of other APIs that can be utilized by the applications 520 and/or other software components/modules, some of which can be specific to a particular operating system or platform.

The applications 520 can include built-in applications 540 and/or third-party applications 542. Representative examples of the built-in applications 540 on a mobile device can include, but are not limited to, a contacts application, a browser application, a book reader application, a location application, a media application, a messaging application, and/or a game application. Third-party applications 542 can include any of the built-in applications as well as a broad assortment of other applications. In a specific example, the third-party application 542 (e.g., an application developed using the Android™ or iOS™ software development kit (SDK) by an entity other than the vendor of the particular platform) can be mobile software running on a mobile operating system such as iOS™, Android™, or other mobile computing device operating systems. In this example, the third-party application 542 can invoke the API calls 524 provided by the mobile operating system such as operating system 514 to facilitate functionality described herein.

The applications 520 can utilize built in operating system functions (e.g., kernel 528, services 530 and/or drivers 532), libraries (e.g., system libraries 534), API libraries 536, and other libraries 538), frameworks/middleware 518 to create user interfaces to interact with users of the system. Alternatively, or additionally, in some systems, interactions with a user can occur through a presentation layer, such as presentation layer 544. In these systems, the application/module “logic” can be separated from the aspects of the application/module that interact with a user.

Some software architectures utilize virtual machines. In the example of FIG. 5, this is illustrated by virtual machine 548. A virtual machine creates a software environment where applications/modules can execute as if they were executing on a hardware computing device. A virtual machine can be hosted by a host operating system (operating system 514) and can include a virtual machine monitor 546 that manages the operation of the virtual machine as well as the interface with the host operating system (i.e., operating system 514). A software architecture executes within the virtual machine 548 such as an operating system 550, libraries 552, frameworks/middleware 554, applications 556 and/or presentation layer 558. These layers of software architecture executing within the virtual machine 548 can be the same as corresponding layers previously described or can be different.

Various examples are described herein as including logic or a number of components, modules, or mechanisms. Components can constitute either software components (e.g., code embodied on a non-transitory machine-readable medium or in a transmission signal) or hardware-implemented components. A hardware-implemented component is a tangible unit capable of performing particular operations and can be configured or arranged in a particular manner. In some examples, one or more computer systems (e.g., a standalone, client, or server computer system) or one or more hardware processors can be configured by software (e.g., an application or application portion) as a hardware-implemented component that operates to perform particular operations as described herein.

In various examples, a hardware-implemented component can be implemented mechanically or electronically. For example, a hardware-implemented component can comprise dedicated circuitry or logic that is permanently configured (e.g., as a special-purpose processor, such as a field programmable gate array (FPGA) or an application-specific integrated circuit (ASIC)) to perform particular operations. A hardware-implemented component can also comprise programmable logic or circuitry (e.g., as encompassed within a general-purpose processor or another programmable processor) that is temporarily configured by software to perform various operations. It will be appreciated that the decision to implement a hardware-implemented component mechanically, in dedicated and permanently configured circuitry, or in temporarily configured circuitry (e.g., configured by software) can be driven by technical, cost, or time considerations.

Accordingly, any of the hardware components or modules described herein is understood to encompass a tangible entity, be that an entity that is physically constructed, permanently configured (e.g., hardwired), or temporarily or transitorily configured (e.g., programmed) to operate in a particular manner and/or to perform particular operations described herein. For examples where hardware-implemented components are temporarily configured (e.g., programmed), these components can remain unconfigured or uninstantiated at any given time. For example, where the hardware-implemented components comprise a general-purpose processor configured using software, the general-purpose processor can be configured as respective different hardware-implemented components at various times. Software can accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components can be regarded as being communicatively coupled. Where multiple of such hardware-implemented components exist contemporaneously, communications can be achieved through signal transmission (e.g., over appropriate circuits and buses that connect the hardware-implemented components). In examples in which multiple hardware-implemented components are configured or instantiated at various times, communications between such hardware-implemented components can be achieved, for example, through the storage and retrieval of information in memory structures to which the multiple hardware-implemented components have access. For example, one hardware-implemented component can perform an operation, and store the output of that operation in a memory device to which it is communicatively coupled. A further hardware-implemented component can then, at a later time, access the memory device to retrieve and process the stored output. Hardware-implemented components can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented devices, systems, or machines that operate to perform one or more operations or functions. Similarly, the methods described herein can be at least partially processor-implemented. For example, at least some of the operations of a method can be performed by one or more processors or processor-implemented devices, systems, or machines. The performance of particular operations can be distributed among the one or more processors, not just residing within a single machine, but deployed across a number of machines. In some examples, the processor or processors can be located in a single location (e.g., within a home environment, an office environment, or a server farm), while in other examples the processors can be distributed across a number of locations.

Examples can be implemented in digital electronic circuitry, or in computer hardware, firmware, or software, or in combinations of them. Examples can be implemented using a computer program product, e.g., a computer program tangibly embodied in an information carrier, e.g., in a machine-readable medium for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a software module, subroutine, or other unit suitable for use in a computing environment. A computer program can be deployed to be executed on one computer or on multiple computers at one site or distributed across multiple sites and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures merit consideration. In other words, the choice of whether to implement particular functionality in permanently configured hardware (e.g., an ASIC), in temporarily configured hardware (e.g., a combination of software and a programmable processor), or in a combination of permanently and temporarily configured hardware can be a design choice. Below are set out hardware (e.g., machine) and software architectures that can be deployed, in various examples.

FIG. 6 is a block diagram illustrating examples of a computer systems 600 for executing software instructions 624 to perform operations of the power electronic device prediction systems discussed herein. In alternative examples, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a personal digital assistant (PDA), a cellular telephone, a web appliance, a network router, switch, or bridge, or any machine capable of executing instructions (sequential or otherwise) that specify actions to be taken by that machine. Further, while a single machine is illustrated, the term “machine” includes any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU), or both), a main memory 604, and a static memory 606, which communicate with each other via an interconnect, bus, or link 608. The computer system 600 can further include a video display unit 610 (e.g., a liquid crystal display (LCD) or a cathode ray tube (CRT)). The computer system 600 can also include an alphanumeric input device 612 (e.g., a keyboard or a touch-sensitive display screen), a user interface (UI) navigation (or cursor control) device 614 (e.g., a mouse), a storage device 616, a signal generation device 618 (e.g., a speaker), and a network interface device 620 in communication with a network 626.

The storage device 616 includes a machine-readable medium 622 on which is stored one or more sets of data structures and software instructions 624 (e.g., software) embodying or utilized by any one or more of the methodologies or functions described herein. The software instructions 624 can also reside, completely or at least partially, within the main memory 604 and/or within the processor 602 during execution thereof by the computer system 600, with the main memory 604 and the processor 602 also constituting a machine-readable medium 622. Data 627 can optionally (and indicated by the dashed lines) on the processor 602, the main memory 604, or both.

While the machine-readable medium 622 is shown in some examples to be a single medium, the term “machine-readable medium” can include a single medium or multiple media (e.g., a centralized or distributed database, and/or associated caches and servers) that store the software instructions 624 or data structures. The term “machine-readable medium” includes any tangible, non-transitory medium that can store, encode, or carry the software instructions 624 for execution by the machine and that cause the machine to perform any one or more of the methodologies of the present disclosure, or that can store, encode, or carry data structures utilized by or associated with the software instructions 624. The term “machine-readable medium” includes, but is not limited to, solid-state memories, and optical and magnetic media. Specific examples of a machine-readable medium 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium as used herein is not a transmission medium.

### Various Notes and Examples

Example 1 is a method for modeling a power electronic device, comprising: training a power electronic device model using training data that includes, a plurality of physical modalities from different power electronic devices, wherein the training data is selected to represent diverse architectures, topologies, and configurations of power electronic devices to enable generalization across unseen power electronic devices; and predicting, using the power electronic device model, at least one physical modality of an unknown power electronic device not seen before by the power electronic device model, wherein the predicting comprises: encoding a plurality of known physical modalities of the unknown power electronic device into embeddings; mapping the embeddings into a latent space configured to represent relationships between the known physical modalities; and decoding a predicted embedding from the latent space to generate the at least one physical modality of the unknown power electronic device, wherein the latent space enables transformations to ensure predictions for devices not previously encountered.

In Example 2, the subject matter of Example 1 includes wherein the training data further comprises unlabeled datasets, and the training of the power electronic device model includes a self-supervised learning technique that employs a pretext task to extract meaningful features from the plurality of physical modalities.

In Example 3, the subject matter of Example 2 includes refining the power electronic device model using a few-shot learning technique with a small number of labeled examples to adapt the power electronic device model to new power electronic devices.

In Example 4, the subject matter of Examples 1-3 includes wherein the latent space is configured to enable transformations between the plurality of physical modalities, including converting time-domain transient responses to frequency-domain loop responses or circuit design parameters.

In Example 5, the subject matter of Examples 1˜4 includes wherein mapping the embeddings into a latent space further comprises using a mapping model to map the embeddings into a latent space, the mapping model trained to represent relationships between the plurality of physical modalities.

In Example 6, the subject matter of Example 5 includes wherein the mapping model is a machine learning model trained to predict unknown embeddings based on known embeddings, and further comprising pre-training the mapping model using self-supervised learning.

In Example 7, the subject matter of Examples 5-6 includes wherein the mapping model is implemented using a generative approach, including autoregressive or diffusion models, to predict embeddings in the latent space.

In Example 8, the subject matter of Examples 1-7 includes wherein the encoding further comprises using a plurality of physical modality encoders to encode the plurality of known physical modalities into embeddings, where the plurality of physical modality encoder are configured to capture characteristics of the plurality of known physical modalities.

In Example 9, the subject matter of Example 8 includes wherein the characteristics of the plurality of known physical modalities include one or more of: (i) nonlinear interactions; (ii) parasitic effects.

In Example 10, the subject matter of Examples 8-9 includes wherein the plurality of physical modality encoders utilize self-supervised learning techniques to extract meaningful features from unlabeled datasets, thereby reducing reliance on labeled data.

In Example 11, the subject matter of Examples 8-10 includes training each of the plurality of physical modality encoders independently, using an individual model for each of the plurality of physical modality encoders, to process diverse physical modalities of the power electronic device such that the power electronic device model can handle multi-modal data specific to power electronic devices.

In Example 12, the subject matter of Examples 8-11 includes training each of the plurality of physical modality encoders jointly, using partially labeled data, to process diverse physical modalities of the power electronic device such that the power electronic device model can handle multi-modal data specific to power electronic devices.

In Example 13, the subject matter of Examples 1-12 includes wherein decoding a predicted embedding from the latent space further comprises using a plurality of physical modality decoders to decode predicted embeddings from the latent space.

In Example 14, the subject matter of Example 13 includes wherein the plurality of physical modality encoders and the plurality of physical modalities decoders form an autoencoder-based architecture, and the latent space is implemented using a variational autoencoder (VAE).

In Example 15, the subject matter of Examples 13-14 includes wherein the plurality of physical modality decoders are configured to generate predicted physical modalities that include efficiency, power factor, harmonic distortion, or temperature stability of the unknown power electronic device.

In Example 16, the subject matter of Examples 1-15 includes generating an output of the power electronic device model that includes both given physical modalities and predicted physical modalities, and the output further comprises text describing at least one of the given physical modalities or predicted physical modalities.

In Example 17, the subject matter of Examples 1-16 includes wherein the power electronic device is a power converter, the power electronic device model is a power converter model, the unknown power electronic device is an unknown power converter, and wherein the plurality of physical modalities includes at least one of: (1) time-domain transient responses; (2) frequency-domain loop responses; (3) circuit design parameters.

Example 18 is a power electronic device prediction system, comprising: a plurality of physical modality encoders configured to encode known physical modalities of a power electronic device into known embeddings; a latent space configured to represent relationships between the known physical modalities and enable transformations from the known embeddings to at least one predicted embedding, wherein the at least one predicted embedding is for an unknown power electronic device that has not been seen before by the power electronic device prediction system; a mapping model configured to predict the at least one predicted embedding based on the known embeddings; a plurality of physical modality decoders configured to decode the at least one predicted embedding from the latent space to generate at least one physical modality of the unknown power electronic device; and an output containing the plurality of known physical modalities and the at least one predicted physical modality of the unknown power electronic device.

In Example 19, the subject matter of Example 18 includes training a power electronic device model, using training data that includes a plurality of physical modalities from different power electronic devices, wherein the unknown power electronic device is one that has not been included in the training data, wherein the power electronics device model includes the mapping model, and wherein the training is performed using a self-supervised learning technique to extract meaningful features from unlabeled datasets to reduce reliance on labeled data, wherein the self-supervised learning technique uses a pretext task to extract meaningful features from the plurality of physical modalities; and refining the power electronic device model using a few-shot learning technique with a small number of labeled examples to adapt the power electronic device model to new power electronic devices.

Example 20 is a non-transitory computer-readable storage medium including instructions that, when executed by a computer, cause the computer to perform operations to predict an unknown physical modality of a power converter, the operations comprising: receiving a plurality of known physical modalities of the power converter into a power converter model, wherein the known physical modalities are selected to represent diverse architectures, topologies, and configurations of power converters; mapping the plurality of known physical modalities into a latent space, wherein the latent space is configured to represent relationships between the known physical modalities and enable transformations between embeddings; predicting, using the power converter model, the unknown physical modality in the latent space to obtain a predicted physical modality, wherein the power converter has not been included in the training data used to train the power converter model; and outputting the plurality of known physical modalities and the predicted physical modality of the power converter; wherein the power converter model is trained using a self-supervised learning technique with unlabeled data comprising physical modalities of a variety of different power converters, and further refined using a few-shot learning technique with labeled data to adapt the model to predict physical modalities of unseen power converters.

Example 21 is a method for modeling a power converter, comprising: training a power converter model using training data including a plurality of physical modalities of different power converters; and predicting, using the power converter model, at least one physical modality of an unknown power converter not seen before by the power converter model.

In Example 22, the subject matter of Example 21 includes wherein training the power converter model further comprises using an unsupervised technique where training data is unlabeled.

In Example 23, the subject matter of Examples 21-22 includes wherein training the power converter model further comprises: training a pre-training model using the training data, which is a plurality of unlabeled datasets containing the physical modalities of several different types of power electronic devices, by employing a pre-task to learn to extract meaningful features from the training data using a self-supervised technique; transferring the meaningful features to a pre-trained mapping model; and refining the pre-trained mapping model using a few-shot learning technique to generate a mapping model for use in the power converter model.

In Example 24, the subject matter of Examples 21-23 includes wherein the training data is unlabeled.

In Example 25, the subject matter of Example 24 includes wherein refining the pre-training model further comprises using the few-shot learning technique and labeled training data, wherein the label training data is much less than the unlabeled training data.

In Example 26, the subject matter of Examples 21-25 includes wherein predicting using the power converter model further comprises: encoding a plurality of known physical modalities of the unknown power converter using a plurality of physical modality encoders into a lower-dimensional representation or embeddings; and mapping the embedding to a latent space using a mapping model to generate known physical modality embeddings.

In Example 27, the subject matter of Example 26 includes predicting a physical modality of the unknown power converter using the mapping model, wherein the predicted physical modality is not in the plurality of known physical modalities; encoding the predicted physical modality, using a physical modality encoder, into a lower-dimensional representation or embedding; and mapping the embedding to the latent space using the mapping model to generate a predicted physical modality embedding.

In Example 28, the subject matter of Example 27 includes decoding the known physical modality embeddings and the predicted physical modality embedding to generate an output containing both given and predicted physical modalities for the unknown power converter.

In Example 29, the subject matter of Example 28 includes wherein the output includes text describing at least one of the given and predicted physical modalities for the unknown power converter.

Example 30 is a power electronic device prediction system comprising: a power electronic device model that has been trained on physical modalities of several different types of a selected power electronic device; a plurality of known physical modalities of an unknown power electronic device, wherein the unknown power electronic device has not been seen before by the power electronic device model; a mapping model of the power electronic device model that maps the plurality of known physical modalities to a predicted physical modality, wherein the plurality of known physical modalities and the predicted physical modality both describe characteristics and behavior of the unknown power electronic device; and an output of the power electronic device prediction system containing the plurality of known physical modalities and the predicted physical modality for the unknown power electronic device.

In Example 31, the subject matter of Example 30 includes wherein the plurality of known physical modalities of the unknown power electronic device is not included in the physical modalities of several different types of the selected power electronic device.

In Example 32, the subject matter of Examples 30-31 includes wherein the power electronic device model is pretrained using a self-supervised technique and the physical modalities of several different types of the selected power electronic device are unlabeled.

In Example 33, the subject matter of Examples 30-32 includes a plurality of unlabeled datasets containing the physical modalities of several different types of the selected power electronic device; a pre-training model that learns to make predictions based on certain parts of the plurality of unlabeled datasets and using other parts of the plurality of unlabeled datasets as context; and a pre-task that is a task that the pre-training model learns to solve discovering inherent structure and patterns present in the plurality of unlabeled datasets, wherein the pre-task is used to train the pre-training model to learn to extract meaningful features from the plurality of unlabeled dataset using a self-supervised technique.

In Example 34, the subject matter of Example 33 includes wherein the mapping model is generated by transferring the meaningful features to the mapping model.

Example 35 is a non-transitory computer-readable storage medium including instructions that, when executed by a computer, cause the computer to perform operations to predict an unknown physical modality of a power converter, the operations comprising: receiving a plurality of known physical modalities of the power converter into a power converter model; mapping the plurality of known physical modalities into a latent space; predicting, using a power converter model, the unknown physical modality in latent space to obtain a predicted physical modality, and outputting the known physical modalities and the predicted physical modality of the power converter, wherein the power converter has not been seen before by the power converter model.

In Example 36, the subject matter of Example 35 includes wherein the power converter is one class of power electronic devices and further comprising using the power converter model to predict physical modalities of other classes of power electronic devices.

In Example 37, the subject matter of Examples 35-36 includes training the power converter model for the unknown physical modality such that the power converter model can predict the unknown physical modality of the power converter.

In Example 38, the subject matter of Example 37 includes wherein the training of the power converter is performed using an unsupervised technique and unlabeled data that is the physical modalities of a variety of different power converters.

In Example 39, the subject matter of Examples 37-38 includes pre-training the power converter model using a self-supervised technique and unlabeled data that is the physical modalities of a variety of different power converters.

In Example 40, the subject matter of Example 39 includes refining the power converter model using a few-shot learning technique and labeled data that is additional physical modalities of the variety of different power converters.

Example 41 is at least one machine-readable medium including instructions that, when executed by processing circuitry, cause the processing circuitry to perform operations to implement of any of Examples 1-40.

Example 42 is an apparatus comprising means to implement of any of Examples 1-40.

Example 43 is a system to implement of any of Examples 1-40.

Example 44 is a method to implement of any of Examples 1-40.

Each of the non-limiting examples described herein can stand on its own or can be combined in various permutations or combinations with one or more of the other examples.

The above detailed description includes references to the accompanying drawings, which form a part of the detailed description. The drawings show, by way of illustration, specific examples in which aspects of the disclosure can be practiced. Such examples can include elements in addition to those shown or described. However, also contemplated are examples in which those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact discs and digital video discs), magnetic cassettes, memory cards or sticks, random access memories (RAMs), read-only memories (ROMs), and the like.

The above description is intended to be illustrative, and not restrictive. For example, the above-described examples (or one or more claims thereof) can be used in combination with each other. Other examples can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This is not to be interpreted as intending that an unclaimed disclosed feature is a part of any claim. Rather, inventive subject matter can lie in less than every feature of a particular disclosed example.

What is claimed is:

1. A method for modeling a power electronic device, comprising:
training a power electronic device model using training data that includes a plurality of physical modalities from different power electronic devices, wherein the training data is selected to represent diverse architectures, topologies, and configurations of power electronic devices to enable generalization across unseen power electronic devices; and
predicting, using the power electronic device model, at least one physical modality of an unknown power electronic device not seen before by the power electronic device model, wherein the predicting comprises:
encoding a plurality of known physical modalities of the unknown power electronic device into embeddings;
mapping the embeddings into a latent space configured to represent relationships between the known physical modalities; and
decoding a predicted embedding from the latent space to generate the at least one physical modality of the unknown power electronic device, wherein the latent space enables transformations to ensure predictions for devices not previously encountered.

2. The method of claim 1, wherein the training data further comprises unlabeled datasets, and the training of the power electronic device model includes a self-supervised learning technique that employs a pretext task to extract meaningful features from the plurality of physical modalities.

3. The method of claim 2, further comprising refining the power electronic device model using a few-shot learning technique with a small number of labeled examples to adapt the power electronic device model to new power electronic devices.

4. The method of claim 1, wherein the latent space is configured to enable transformations between the plurality of physical modalities, including converting time-domain transient responses to frequency-domain loop responses or circuit design parameters.

5. The method of claim 1, wherein mapping the embeddings into a latent space further comprises using a mapping model to map the embeddings into a latent space, the mapping model trained to represent relationships between the plurality of physical modalities.

6. The method of claim 5, wherein the mapping model is a machine learning model trained to predict unknown embeddings based on known embeddings, and further comprising pre-training the mapping model using self-supervised learning.

7. The method of claim 5, wherein the mapping model is implemented using a generative approach, including autoregressive or diffusion models, to predict embeddings in the latent space.

8. The method of claim 1, wherein the encoding further comprises using a plurality of physical modality encoders to encode the plurality of known physical modalities into embeddings, where the plurality of physical modality encoder are configured to capture characteristics of the plurality of known physical modalities.

9. The method of claim 8, wherein the characteristics of the plurality of known physical modalities include one or more of: (i) nonlinear interactions; (ii) parasitic effects.

10. The method of claim 8, wherein the plurality of physical modality encoders utilize self-supervised learning techniques to extract meaningful features from unlabeled datasets, thereby reducing reliance on labeled data.

11. The method of claim 8, further comprising training each of the plurality of physical modality encoders independently, using an individual model for each of the plurality of physical modality encoders, to process diverse physical modalities of the power electronic device such that the power electronic device model can handle multi-modal data specific to power electronic devices.

12. The method of claim 8, further comprising training each of the plurality of physical modality encoders jointly, using partially labeled data, to process diverse physical modalities of the power electronic device such that the power electronic device model can handle multi-modal data specific to power electronic devices.

13. The method of claim 1, wherein decoding a predicted embedding from the latent space further comprises using a plurality of physical modality decoders to decode predicted embeddings from the latent space.

14. The method of claim 13, wherein the plurality of physical modality encoders and the plurality of physical modalities decoders form an autoencoder-based architecture, and the latent space is implemented using a variational autoencoder (VAE).

15. The method of claim 13, wherein the plurality of physical modality decoders are configured to generate predicted physical modalities that include efficiency, power factor, harmonic distortion, or temperature stability of the unknown power electronic device.

16. The method of claim 1, further comprising generating an output of the power electronic device model that includes both given physical modalities and predicted physical modalities, and the output further comprises text describing at least one of the given physical modalities or predicted physical modalities.

17. The method of claim 1, wherein the power electronic device is a power converter, the power electronic device model is a power converter model, the unknown power electronic device is an unknown power converter, and wherein the plurality of physical modalities includes at least one of: (1) time-domain transient responses; (2) frequency-domain loop responses; (3) circuit design parameters.

18. A power electronic device prediction system, comprising:
a plurality of physical modality encoders configured to encode known physical modalities of a power electronic device into known embeddings;
a latent space configured to represent relationships between the known physical modalities and enable transformations from the known embeddings to at least one predicted embedding, wherein the at least one predicted embedding is for an unknown power electronic device that has not been seen before by the power electronic device prediction system;
a mapping model configured to predict the at least one predicted embedding based on the known embeddings;
a plurality of physical modality decoders configured to decode the at least one predicted embedding from the latent space to generate at least one physical modality of the unknown power electronic device; and
an output containing the plurality of known physical modalities and the at least one predicted physical modality of the unknown power electronic device.

19. The power electronic device prediction system of claim 18, further comprising:
training a power electronic device model, using training data that includes a plurality of physical modalities from different power electronic devices, wherein the unknown power electronic device is one that has not been included in the training data, wherein the power electronics device model includes the mapping model, and wherein the training is performed using a self-supervised learning technique to extract meaningful features from unlabeled datasets to reduce reliance on labeled data, wherein the self-supervised learning technique uses a pretext task to extract meaningful features from the plurality of physical modalities; and
refining the power electronic device model using a few-shot learning technique with a small number of labeled examples to adapt the power electronic device model to new power electronic devices.

20. A non-transitory computer-readable storage medium including instructions that, when executed by a computer, cause the computer to perform operations to predict an unknown physical modality of a power converter, the operations comprising:
receiving a plurality of known physical modalities of the power converter into a power converter model, wherein the known physical modalities are selected to represent diverse architectures, topologies, and configurations of power converters;
mapping the plurality of known physical modalities into a latent space, wherein the latent space is configured to represent relationships between the known physical modalities and enable transformations between embeddings;
predicting, using the power converter model, the unknown physical modality in the latent space to obtain a predicted physical modality, wherein the power converter has not been included in the training data used to train the power converter model; and
outputting the plurality of known physical modalities and the predicted physical modality of the power converter;
wherein the power converter model is trained using a self-supervised learning technique with unlabeled data comprising physical modalities of a variety of different power converters, and further refined using a few-shot learning technique with labeled data to adapt the model to predict physical modalities of unseen power converters.
